(19) United States
(12) Patent Application Publication
(10) Pub. No.: US 2016/0373509 A1
(43) Pub. Date: Dec. 22, 2016

(54) APPARATUS AND METHOD FOR REPORTING QoS/QoE IN MOBILE ENVIRONMENT

(71) Applicant: SK Telecom Co., Ltd., Seoul (KR)

(72) Inventor: Jongmin LEE, Seoul (KR)

(21) Appl. No.: 15/183,242

(22) Filed: Jun. 15, 2016

Related U.S. Application Data
(60) Provisional application No. 62/180,295, filed on Jun. 16, 2015.
(60) Provisional application No. 62/184,979, filed on Jun. 26, 2015.

(51) Int. Cl. H04L 29/06; H04W 24/08

(52) U.S. Cl. CPC H04L 65/80; H04W 24/08; H04W 24/10

(57) ABSTRACT

The present invention relates to an apparatus and method for reporting quality of a mobile streaming service. A terminal device provided with a mobile streaming service through at least one communication network measures quality of the streaming service, generates a mobile service quality indicator for monitoring quality of service (QoS) or quality of experience (QoE) based on the measurement result, and reports the generated mobile service quality indicator in real time through a message queue interface (MQI) message, a network abstraction for media (NAM) feedback message, etc., so that network conditions may be effectively monitored even in a mobile streaming environment.

### CROSS-REFERENCE TO RELATED APPLICATION

This application claims priority to and the benefit of U.S. Patent Application No. 62/180,295 and 62/184,979 filed in the United States Patent and Trademark Office on Jun. 16, 2015 and on Jun. 26, 2015, the entire contents of which are incorporated herein by reference.

### TECHNICAL FIELD

The present invention relates to an apparatus and method for reporting quality of a mobile streaming service, and more particularly, to a method in which a terminal device provided with a mobile streaming service through at least one communication network measures quality of the streaming service, generates a mobile service quality indicator based on the measurement result, and reports the generated mobile service quality indicator and the terminal device.

### BACKGROUND

Descriptions made in this section merely provide background information of embodiments of the present invention and do not constitute conventional art.

A real-time multimedia service refers to one of the methods of transmitting multimedia data, that is, a way in which audio and video content is played or consumed. Such real-time multimedia services may be classified into a conversational service, an interactive service, and a streaming service according to service types. According to the streaming service, without downloading a large amount of multimedia data as a whole, it is possible to play the data just as soon as only some of the data to be currently played is received.

Due to such a streaming service, live broadcasting services such as a live broadcast may ensure a real-time characteristic compared to an existing download service.

Meanwhile, the current service consumption pattern of streaming service users is changing from a wired network streaming service for an Internet protocol television (IPTV), etc. to a wireless network streaming service for a mobile device. Therefore, there is a trend toward increased traffic of a mobile streaming service, and it is very important to make a service level agreement (SLA) in such a mobile streaming service environment.

Also, a mobile streaming service environment varies more than a streaming service environment based on a wired network. Therefore, to provide a stable service, it is necessary to check quality indicators related to a streaming service in a mobile network periodically or as the occasion demands.

In a wired network streaming service for a fixed IPTV, etc., a set-top box monitors and provides quality of service (QoS) or quality of experience (QoE) in real time, but in a mobile streaming environment, it is difficult to monitor network conditions, such as QoS, QoE, etc., in real time.

### SUMMARY

The present invention is directed to providing a method of reporting network conditions, such as quality of service (QoS) or quality of experience (QoE), in a wireless environment in which a real-time streaming service is provided.

One aspect of the present invention provides a method of reporting service quality to a content providing device by a terminal device provided with content through mobile streaming, the method including: measuring, by the terminal device, quality of a streaming service provided by the content providing device; and generating a mobile service quality indicator based on a measurement result and transmitting the mobile service quality indicator to the content providing device.

Here, the mobile service quality indicator may be included in any one of a message queue interface (MQI) message and a network abstraction for media (NAM) feedback message and transmitted. The MQI message or the NAM feedback message may include at least one of a time (generation_time) at which the MQI message or the NAM feedback message was generated, identification information (client_id/device_id) of the terminal device, a processing capability (device_capability) of the terminal device, a cell identifier (ID) (Time_C_id/C_id) of an area in which the terminal device is located, a duration (Rebuffering_duration) of a buffer underrun during one period or a number of buffer underruns (Buffer_underrun) occurring during one period, an interval (Jitter_duration) between packets during one period, a number of packets (packet_loss_count/packet loss) lost during transmission of data of the content, a type (interface_type) of a wireless network connected to the terminal device, a content error indicator (video_quality), an indicator (SRR) of a content transmission rate, and a moving speed (moving_speed) of the terminal device. When the MQI message or the NAM feedback message includes the cell ID, the MQI message or the NAM feedback message may further include information on a time at which the terminal device was located in a cell corresponding to the cell ID.

The content error indicator (video_quality) may be an indicator representing at least one of a freeze error (freeze), a black error (black), and a macroblock error (mb). The NAM feedback message may further include at least one of cross layer interface (CLI) identification information (CLI_id), an available bitrate (available_bitrate), a total buffer size (buffer_fullness), a maximum bitrate (peak_bitrate), an average bitrate (average_birate_period), a current delay time (current_delay), and a bit error rate (BER). When flag information (NAM_flag) in the NAM feedback message is 1, the available bitrate (available_bitrate), the total buffer size (buffer_fullness), and the maximum bitrate (peak_bitrate) may denote an absolute available bitrate, an absolute total buffer size, and an absolute maximum bitrate, and when the flag information (NAM_flag) is 0, the available bitrate (available_bitrate), the total buffer size (buffer_fullness), and the maximum bitrate (peak_bitrate) may denote a relative available bitrate (relative_available_bitrate), a relative total buffer size (relative_buffer_fullness), and a relative maximum bitrate (relative_peak_bitrate).

Another aspect of the present invention provides a computer-readable recording medium storing a program for carrying out the above-described method.

Still another aspect of the present invention provides a terminal device provided with content through mobile streaming, the terminal device including: a communication module configured to operate in conjunction with a content providing device through at least one communication network and exchange content data with the content providing device; and a control module configured to measure quality of a streaming service provided by the content providing device, generate a mobile service quality indicator based on a measurement result, and control the communication module to transmit the generated indicator to the content providing device.

Here, the mobile service quality indicator may be included in any one of an MQI message and an NAM feedback message and transmitted. The MQI message or the NAM feedback message may include at least one of a time (generation_time) at which the MQI message or the NAM feedback message was generated, identification information (client_id/device_id) of the terminal device, a processing capability (device_capability) of the terminal device, a cell ID (Time_C_id/C_id) of an area in which the terminal device is located, a duration (Rebuffering_duration) of a buffer underrun during one period or a number of buffer underruns (Buffer_underrun) occurring during one period, an interval (Jitter_duration) between packets during one period, a number of packets (packet_loss_count/packet loss) lost during transmission of the content data, a type (interface_type) of a wireless network connected to the terminal device, a content error indicator (video_quality), an indicator (SRR) of a content transmission rate, and a moving speed (moving_speed) of the terminal device. When the MQI message or the NAM feedback message includes the cell ID, the MQI message or the NAM feedback message may further include information on a time at which the terminal device was located in a cell corresponding to the cell ID.

The content error indicator (video_quality) may be an indicator representing at least one of a freeze error (freeze), a black error (black), and a macroblock error (mb). The NAM feedback message may further include at least one of CLI identification information (CLI_id), an available bitrate (available_bitrate), a total buffer size (buffer_fullness), a maximum bitrate (peak_bitrate), an average bitrate (average_birate_period), a current delay time (current_delay), and a BER. When flag information (NAM_flag) in the NAM feedback message is 1, the available bitrate (available_bitrate), the total buffer size (buffer_fullness), and the maximum bitrate (peak_bitrate) may denote an absolute available bitrate, an absolute total buffer size, and an absolute maximum bitrate, and when flag information (NAM_flag) is 0, the available bitrate (available_bitrate), the total buffer size (buffer_fullness), and the maximum bitrate (peak_bitrate) may denote a relative available bitrate (relative_available_bitrate), a relative total buffer size (relative_buffer_fullness), and a relative maximum bitrate (relative_peak_bitrate).

### BRIEF DESCRIPTION OF DRAWINGS

FIG. 1 is a diagram illustrating a configuration of a system for implementing a method of reporting service quality according to an embodiment of the present invention.

FIG. 2 is a block diagram showing a main configuration of a terminal device according to an embodiment of the present invention.

FIGS. 3 and 4 are diagrams illustrating the syntax of message queue interface (MQI) messages according to an embodiment of the present invention.

FIGS. 5 and 6 are diagrams illustrating the syntax of network abstraction for media (NAM) feedback messages according to an embodiment of the present invention.

### DETAILED DESCRIPTION

Embodiments of the present invention will now be described more fully with reference to the accompanying drawings to clarify features and advantages of the present invention.

In the detailed description of embodiments of the present invention, when detailed descriptions of the known art related to the present invention are determined to obscure the subject matter of the present invention, the detailed descriptions will be omitted. Throughout the drawings, like elements are noted by like numerals as much as possible.

Terms or words used in this specification and claims described below are not to be construed as common or dictionary meanings but are to be construed as meanings and concepts in accordance with the technical spirit of the present invention based on a principle that the inventor can define terms appropriately for best explaining his or her own invention. Therefore, embodiments described in the present specification and configurations shown in the drawings are merely exemplary embodiments of the present invention and do not represent the whole technical spirit of the present invention. Thus, it is to be understood that there can be various equivalents and modifications at the filing date of the present invention.

Although terms including ordinal numbers, such as “first.” “second,” etc., may be used to describe various components, the components should not be defined by such terms. Such terms are used only for the purpose of distinguishing one component from another component. For example, a first component may be designated a second component without departing from the scope of the present invention and, similarly, the second component may also be designated the first component.

The terminology used herein to describe embodiments of the invention is not intended to limit the scope of the invention. Elements of the invention referred to in the singular may number one or more, unless the context clearly indicates otherwise. It will be further understood that the terms “comprise.” “include,” etc., when used herein, specify the presence of stated features, numbers, steps, operations, components, parts, or combinations thereof, but do not preclude the presence or addition of one or more other features, numbers, steps, operations, components, parts, or combinations thereof.

Also, the terms “ . . . unit,” “ . . . er,” “module.” etc. used herein indicate units for processing at least one function or operation and may be implemented by hardware, software, or combinations thereof. Further, the singular forms “a,” “an,” “one,” “the,” etc. include plural referents unless the context (particularly in the context of the claims) clearly dictates otherwise.

Besides the terms mentioned above, particular terms used in the following description are provided to aid in understanding the present invention. These particular terms may vary without departing from the technical spirit of the present invention.

Embodiments of the present invention include a computer-readable medium which has computer-executable instructions or has or transfers a data structure stored therein. The computer-readable medium may be any available medium which is accessible by a general or special purpose computer system. For example, the computer-readable medium may include a physical storage medium, such as a random access memory (RAM), a read-only memory (ROM), an erasable programmable ROM (EPROM), a compact disc ROM (CD-ROM), other optical disk storage devices, a magnetic disk storage device, other magnetic storage devices, or any other medium which may be used to store and transfer a certain program code means having the form of computer-executable instructions, computer-readable instructions, or data structures and may be accessed by a general or special purpose computer system, but is not limited thereto.

In the following descriptions and claims, it is assumed that a technical background for implementing a method of reporting service quality according to the present invention is Moving Picture Experts Group (MPEG) media transport (MMT).

In other words, a content providing device 300 described in an embodiment of the present invention may be an MMT aware network entity (MANE) of the MPEG media transport protocol (MMTP) or an external server which stores and transmits streaming content.

However, this is merely an example for aiding in understanding the present invention, and the present invention is not limited to MMT.

Hereinafter, a method of reporting service quality according to an exemplary embodiment of the present invention will be described in detail with reference to drawings.

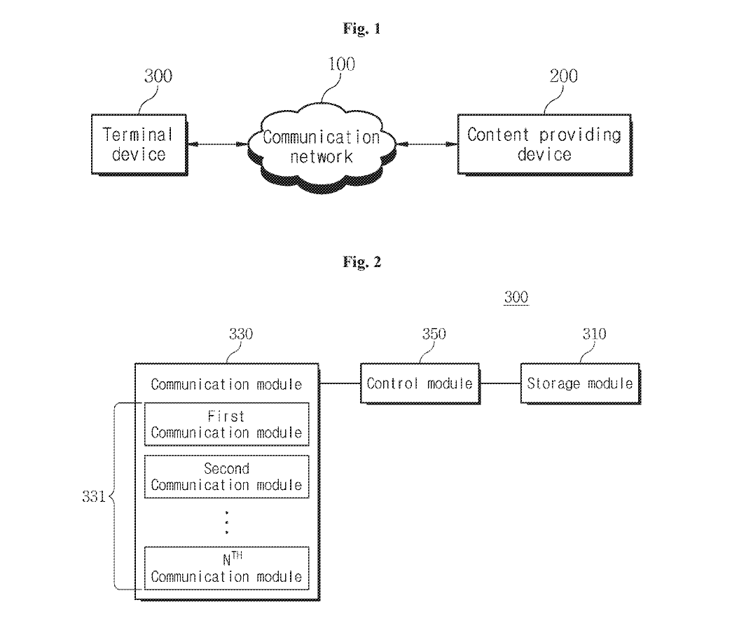

FIG. 1 is a diagram illustrating a configuration of a system for reporting service quality in a mobile streaming service according to an embodiment of the present invention.

Referring to FIG. 1, the system for reporting quality of a mobile streaming service according to an embodiment of the present invention may include a content providing device 200 and a terminal device 300. The content providing device 200 and the terminal device 300 operate in conjunction with each other through a communication network 100.

Each constituent will now be briefly described with reference to FIG. 1.

First, the communication network 100 serves to transfer data for data exchange between the content providing device 200 and the terminal device 300. The communication network 100 may use wireless communication methods, such as wireless local area network (WLAN), wireless fidelity (WiFi), wireless broadband (WiBro), worldwide interoperability for microwave access (WiMAX), high speed downlink packet access (HSDPA), Long Term Evolution (LTE), LTE-advanced (A) network, and so on. Besides the aforementioned communication methods, any communication method which is widely known or will be implemented in the future may be used.

The content providing device 200 is a device for transmitting content data, such as a video, etc., which is stored therein or received from an external device (not shown) to the terminal device 300 through the communication network 100.

The content providing device 200 may transmit content data to the terminal device 300 in units of packets. As mentioned above, the packets may be MMT packets.

Particularly, in the present invention, the content providing device 200 transmits content optimized for a current mobile service environment with reference to a mobile service quality indicator included in a message queue interface (MQI) message, a network abstraction for media (NAM) feedback message, etc. received from the terminal device 300, thereby improving quality of service (QoS) or quality of experience (QoE) provided to a user.

For example, the content providing device 200 may increase or reduce the resolution of video content with reference to an MQI message or an NAM feedback message transmitted by the terminal device 300 and transmit the video content.

In other words, the content providing device 200 determines whether to adjust the spatial resolution or temporal resolution of the video content based on the MQI message or the NAM feedback message, determines whether to transmit the video content with high definition (HD) quality or standard definition (SD) quality or whether to transmit the video content with a frame rate of 30 fps or 60 fps, and transmits the video content to the terminal device 300.

In another example, the content providing device 200 may change a communication network for content transmission with reference to the MQI message or the NAM feedback message transmitted by the terminal device 300.

In other words, the content providing device 200 may monitor traffic according to LTE, WiFi, etc. communication networks with reference to the MQI message or the NAM feedback message. Then, the content providing device 200 may transmit the content to the terminal device 300 through an LTE network or a WiFi network based on the monitoring result. In this way, the content providing device 200 may adjust the amount of traffic according to communication networks, thereby improving the QoS or QoE provided to the user.

As the occasion demands, the content providing device 200 may adjust the amount of traffic by transmitting some of the video content through an LTE network and transmitting the rest of the video content through a WiFi network, thereby improving QoS or QoE.

In other words, the content providing device 200 may transmit traffic in a distributed manner through multiple paths, such as transmit video data through an LTE network and transmit audio data through a WiFi network, according to the service quality indicator with reference to the MQI message or the NAM feedback message transmitted by the terminal device 300. Also, according to the service quality indicator, the content providing device 200 may transmit 1 frame of video data through a WiFi network and transmit B and P frames through an LTE network, thereby adjusting the amount of traffic.

Finally, the terminal device 300 according to the present invention may request content transmission from the content providing device 200 according to an input of the user and receive content from the content providing device 200 in a streaming manner.

At this time, the content may be received in units of packets, and the packets may be MMT packets.

In particular, the terminal device 300 according to the present invention may measure quality of a streaming service provided by the content providing device 200 and generate a mobile service quality indicator based on the measurement result. Meanwhile, the terminal device 300 may include the mobile service quality indicator in an MQI message or an NAM feedback message and transmit the MQI message or the NAM feedback message to the content providing device 200, thereby reporting mobile service quality to the content providing device 200.

Referring to FIG. 2, the terminal device 300 may be configured with a storage module 310, a communication module 330, and a control module 350.

The storage module 310 may store content received through the communication module 330.

In particular, according to a characteristic of the streaming service, the storage module 310 may include a buffer (not shown) which temporarily stores received content for a certain time period.

The communication module 330 is intended to exchange data with the content providing device 200 through the communication network 100. Through the communication module 330, the communication module 330 may request the provision of content according to an input of the user and receive the content according to the request. Also, the communication module 330 may transmit the MQI message or the NAM feedback message including the mobile service quality indicator measured by the terminal device 300 to the content providing device 200.

In particular, the communication module 330 according to the present invention may be divided into one or more communication modules 331 to access one or more communication networks.

For example, a first communication module 331 may be a communication module for accessing an LTE network, and a second communication module 331 may be a communication module for accessing a WiFi network.

The control module 350 is a device which controls the overall operation process of the terminal device 300 according to the present invention.

In particular, the control module 350 according to the present invention measures quality of the streaming service provided by the content providing device 200, generates the mobile service quality indicator based on the measurement result, and controls the communication module 330 to transmit the mobile service quality indicator to the content providing device 200.

At this time, the mobile service quality indicator may be included in the MQI message or the NAM feedback message and transmitted.

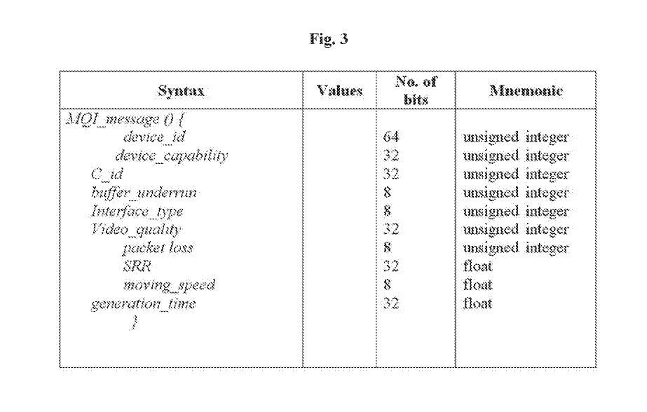

Examples of the MQI message and the NAM feedback message including the mobile service quality indicator will now be described with reference to FIGS. 3 to 6.

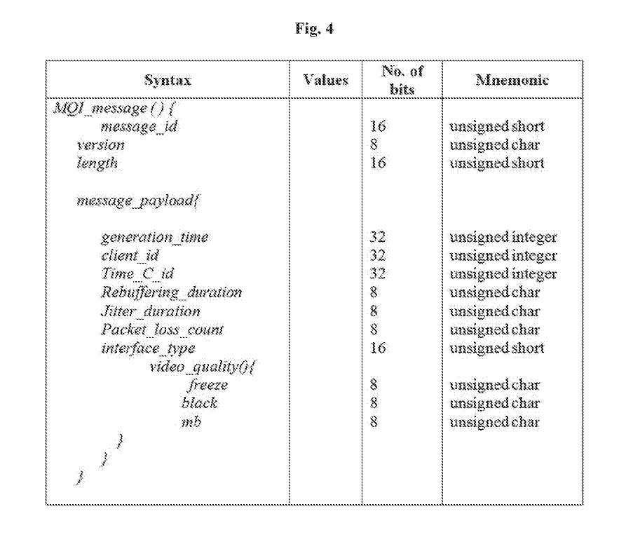

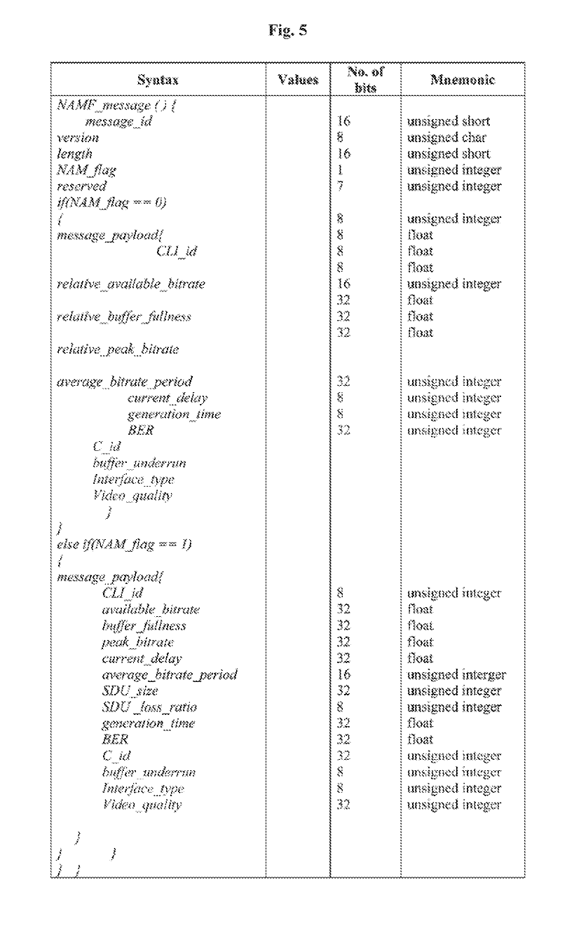

FIGS. 3 and 4 are diagrams illustrating examples of the syntax of an MQI message according to an embodiment of the present invention.

First, referring to FIG. 3 as an example of the syntax of an MQI message according to the present invention, the MQI message may include a “device_id” field indicating identification information of the terminal device 300. Representatively, identification information of the terminal device 300 included in the “device_id” field may be a phone number assigned to the terminal device 300, and the length of the “device_id” field may be 64 bits.

Also, the MQI message may include a “device_capability” field indicating a processing capability of the terminal device 300. The processing capability may be the resolution of an image, etc. processable by the terminal device 300, and the length may be 32 bits.

A “C_id” field may be a cell identifier (ID) of an area in which the terminal device 300 is located, and the length may be 32 bits.

A “buffer_underrun” field may be an indicator representing the number of buffer underruns occurring during one period, and the length may be 8 bits.

An “Interface_type” field indicates the type of a wireless network currently connected to the terminal device 300. Wireless networks connected to the terminal device 300 may include a WiFi network, an LTE network, etc., and the length may be 8 bits.

A “Video_quality” field indicates the number of freeze errors (freeze), black errors (black), macroblock errors (mb). etc. occurring in video content during one period, and the length may be 32 bits.

A “packet loss” field indicates the number of packets lost during transmission of content data, and the length may be 8 bits.

An “SRR” field indicates an indicator of content transmission rates, such as a signal-to-interference-plus-noise ratio (SINR), a reference signal received power (RSRP), a reference signal received quality (RSRQ), etc., and the length may be 32 bits.

A “moving_speed” field indicates a moving speed of the terminal device 300, and the length may be 8 bits.

A “generation_time” field indicates a time at which the MQI message was generated and may be expressed in units of milliseconds. The length of the “generation_time” field may be 32 bits.

Next, another example of syntax of an MQI message according to the present invention will be described with reference to FIG. 4.

Among fields included in the MQI message of FIG. 4, a “generation_time” field, a “Rebuffering_duration” field, and an “Interface_type” field are respectively identical to the “generation_time” field, the “buffer_underrun” field, and the “Interface_type” field of FIG. 3, and thus the descriptions thereof will not be reiterated.

A “client_id” field indicates identification information of the terminal device 300, and a representative example of the identification information may be a mobile station international subscriber directory number (MSISDN). The “client_id” field may have a length of 32 bits.

A “Time_C_id” field may include not only a cell ID of an area in which the terminal device 300 is located but also information on a time at which the terminal device 300 was located in the corresponding cell. A representative value which may correspond to the “Time_C_id” field may be a cell global identifier (CGI) and an evolved universal terrestrial radio access network (E-UTRAN) CGI (eCGI), and the length may be 32 bits.

A “Jitter_duration” field indicates the interval between packets during one period and may have a length of 8 bits.

A “Packet_loss_count” field is an indicator representing how many packets have been lost during transmission of content data and may have a length of 8 bits.

A “video_quality” field is an indicator representing the numbers of errors occurring in video content according to error types, and such error types may be a freeze error (freeze), a black error (black), and a macroblock error (mb).

Meanwhile, the numbers of errors may be measured according to error types and presented in the “video_quality” field, and the length of a field allocated to each error type may be 8 bits.

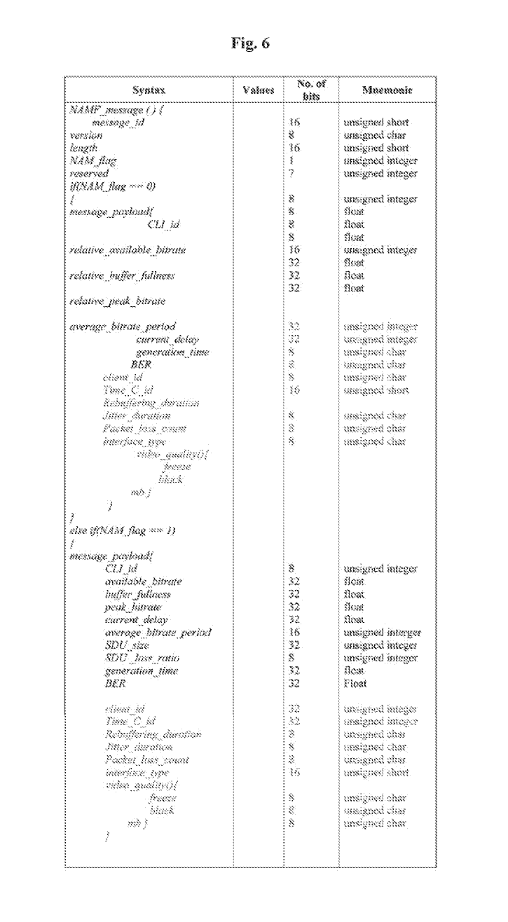

Examples of the syntax of an NAM feedback message in the case of transmitting the NAM feedback message including a mobile service quality indicator to the content providing device 200 will now be described with reference to FIGS. 5 and 6.

Referring to FIG. 5 as an example of the syntax of an NAM feedback message according to the present invention, the NAM message may include a “message_id” field of 16 bits and a “version” field of 8 bits. Also, the NAM message may include a “length” field of 16 bits, an “NAM_flag” field of 1 bit which is flag information of the NAM feedback message, and a “reserved” field of 7 bits.

When the “NAM_flag” field has a value of 0, a “CLI_id” field indicating identification information of a cross layer interface (CLI) may be included with a length of 8 bits. Also, a “relative_available_bitrate” field indicating a relative available bitrate may be included with a length of 8 bits.

A “relative_buffer_fullness” field indicates a relative buffer size and may have 16 bits.

A “relative_peak_bitrate” field indicates a relative maximum bitrate and may have 32 bits.

An “average_bitrate_period” field indicates an average bitrate during one period and may have 32 bits.

A “current_delay” field indicates delay information of currently transmitted content and may have 32 bits.

A “BER” field indicates a bit error rate (BER).

A “C_id” field, a “buffer_underrun” field, an “Interface_type” field, a “Video_quality” field, and a “generation_time” field are identical to the “C_id” field, the “buffer_underrun” field, the “Interface_type” field, the “Video_quality” field, and the “generation_time” field of FIG. 3, and thus the descriptions thereof will not be reiterated.

Meanwhile, when the “NAM_flag” field has a value of 1, an “available_bitrate” field indicating an absolute available bitrate is included with a length of 32 bits.

A “buffer_fullness” field indicating an absolute buffer size is included with a length of 32 bits.

A “peak_bitrate” field indicating a maximum bitrate may have a length of 32 bits.

An “SDU_size” field may have a length of 32 bits and indicates the size of a service data unit (SDU).

An “SDU_loss_ratio” field indicates a loss ratio of SDUs and may have a length of 8 bits.

A “CLI_id” field, an “average_bitrate_period” field, a “generation_time” field, a “BER” field, a “C_id” field, a “buffer_underrun” field, an “Interface_type” field, and a “Video_quality” field are identical to those of a case in which the “NAM_flag” field has a value of 0, and thus the descriptions thereof will not be reiterated.

Next, another example of syntax of an NAM feedback message according to the present invention will be described with reference to FIG. 6.

Like the NAM feedback message of FIG. 5, the NAM feedback message of FIG. 6 may also include a “message_id” field, a “version” field, a “length” field, an “NAM_flag” field, and a “reserved” field.

When the “NAM_flag” field has a value of 0, a “CLI_id” field, a “relative_available_bitrate” field, a “relative_buffer_fullness” field, a “relative_peak_bitrate” field, an “average_bitrate_period” field, a “current_delay” field, a “generation_time” field, a “BER” field, a “client_id” field, a “Time_C_id” field, a “Rebuffering_duration” field, a “Jitter_duration” field, a “Packet_loss_count” field, an “interface_type” field, and a “video_quality” field may be included. The “CLI_id” field, the “relative_available_bitrate” field, the “relative_buffer_fullness” field, the “relative_peak_bitrate” field, the “average_bitrate_period” field, the “current_delav” field, and the “BER” field are identical to the “CLI_id” field, the “relative_available_bitrate” field, the “relative_bufferfullness” field, the “relative_peak_bitrate” field, the “average_bitrate_period” field, the “current_delay” field, and the “BER” field of a case in which the “NAM_flag” field of FIG. 5 has a value of 0.

Also, the “generation_time” field, the “client_id” field, the “Time_C_id” field, the “Rebuffering_duration” field, the “Jitter_duration” field, the “Packet_loss_count” field, the “interface_type” field, and the “video_quality” field are identical to the “generation_time” field, the “client_id” field, the “Time_C_id” field, the “Rebuffering_duration” field, the “Jitter_duration” field, the “Packet_loss_count” field, the “interface_type” field, and the “video_quality” field of FIG. 4.

Meanwhile, when the “NAM_flag” field has a value of 1, the “CLI_id” field, an “available_bitrate” field, a “buffer_fullness” field, a “peak_bitrate” field, the “average_bitrate_period” field, the “current_delay” field, an “SDU_size” field, an “SDU_loss_ratio” field, the “generation_time” field, the “BER” field, the “client_id” field, the “Time_C_id” field, the “Rebuffering_duration” field, the “Jitter_duration” field, the “Packet_loss_count” field, the “interface_type” field, and the “video_quality” field may be included. The “CLI_id” field, “the available_bitrate” field, the “buffer_fullness” field, the “peak_bitrate” field, the “average_bitrateperiod” field, the “current_delay” field, the “SDU_size” field, the “SDU_loss_ratio” field, the “generation_time” field, and the “BER” field are identical to the “CLI_id” field, the “available_bitrate” field, the “buffer_fullness” field, the “peak_bitrate” field, the “average_bitrate_period” field, the “current_delay” field, the “SDU_size” field, the “SDU_loss_ratio” field, the “generation_time” field, and the “BER” field of a case in which the “NAM_flag” field of FIG. 5 has a value of 1.

Also, the “generation_time” field, the “client_id” field, the “Time_C_id” field, the “Rebuffering_duration” field, the “Jitter_duration” field, the “Packet_loss_count” field, the “interface_type” field, and the “video_quality” field are identical to the “generation_time” field, the “client_id” field, the “Time_C_id” field, the “Rebuffering_duration” field, the “Jitter_duration” field, the “Packet_loss_count” field, the “interface_type” field, and the “video_quality” field of FIG. 4.

As described above, this specification includes many particular implementation details. These particular implementation details are not meant to be construed as limitations on the scope of the invention or of what may be claimed, but rather as descriptions of features specific to particular embodiments of the invention.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

This written description sets forth the best mode of the invention and provides examples to describe the invention and to enable those of ordinary skill in the art to implement and use the invention. This written description does not limit the invention to the precise terms set forth. Thus, while the invention has been described in detail with reference to the examples set forth above, those of ordinary skill in the art may effect alterations, modifications, and variations to the examples without departing from the scope of the invention.

Consequently, the scope of the present invention should be determined by the claims rather than the described embodiments.

What is claimed is:

1. A method of reporting service quality to a service providing device by a terminal device provided with content through mobile streaming, the method comprising;
measuring, by the terminal device, quality of a streaming service provided by the content providing device; and
generating a mobile service quality indicator based on a measurement result and transmitting the mobile service quality indicator to the content providing device.

2. The method of claim 1, wherein the mobile service quality indicator is included in any one of a message queue interface (MQI) message and a network abstraction for media (NAM) feedback message and transmitted.

3. The method of claim 2, wherein the MQI message or the NAM feedback message includes at least one of a time (generation_time) at which the MQI message or the NAM feedback message was generated, identification information (client_id/device_id) of the terminal device, a processing capability (device_capability) of the terminal device, a cell identifier (ID) (Time_C_id/C_id) of an area in which the terminal device is located, a duration (Rebuffering_duration) of a buffer underrun during one period or a number of buffer underruns (Buffer_underrun) occurring during one period, an interval (Jitter_duration) between packets during one period, a number of packets (packet_loss_count/packet loss) lost during transmission of data of the content, a type (interface_type) of a wireless network connected to the terminal device, a content error indicator (video_quality), an indicator (SRR) of a content transmission rate, and a moving speed (moving_speed) of the terminal device.

4. The method of claim 3, wherein, when the MQI message or the NAM feedback message includes the cell ID, the MQI message or the NAM feedback message further includes information on a time at which the terminal device was located in a cell corresponding to the cell ID.

5. The method of claim 3, wherein the content error indicator (video_quality) is an indicator representing at least one of a freeze error (freeze), a black error (black), and a macroblock error (mb).

6. The method of claim 3, wherein the NAM feedback message further includes at least one of cross layer interface (CLI) identification information (CLI_id), an available bitrate (available_bitrate), a total buffer size (buffer_fullness), a maximum bitrate (peak_bitrate), an average bitrate (average_birate_period), a current delay time (current_delay), and a bit error rate (BER).

7. The method of claim 6, wherein, when flag information (NAM_flag) in the NAM feedback message is 1, the available bitrate (available_bitrate), the total buffer size (buffer_fullness), and the maximum bitrate (peak_bitrate) denote an absolute available bitrate, an absolute total buffer size, and an absolute maximum bitrate, and
when the flag information (NAM_flag) is 0, the available bitrate (available_bitrate), the total buffer size (buffer_fullness), and the maximum bitrate (peak_bitrate) denote a relative available bitrate (relative_available_bitrate), a relative total buffer size (relative_buffer_fullness), and a relative maximum bitrate (relative_peak_bitrate).

8. A computer-readable recording medium storing a program for carrying out the method of claim 1.

9. A terminal device provided with content through mobile streaming, the terminal device comprising:
a communication module configured to operate in conjunction with a content providing device through at least one communication network and exchange content data with the content providing device; and
a control module configured to measure quality of a streaming service provided by the content providing device, generate a mobile service quality indicator based on a measurement result, and control the communication module to transmit the generated indicator to the content providing device.

10. The terminal device of claim 9, wherein the mobile service quality indicator is included in any one of a message queue interface (MQI) message and a network abstraction for media (NAM) feedback message and transmitted.

11. The terminal device of claim 10, wherein the MQI message or the NAM feedback message includes at least one of a time (generation_time) at which the MQI message or the NAM feedback message was generated, identification information (client_id/device_id) of the terminal device, a processing capability (device_capability) of the terminal device, a cell identifier (ID) (Time_C_id/C_id) of an area in which the terminal device is located, a duration (Rebuffering_duration) of a buffer underrun during one period or a number of buffer underruns (Buffer_underrun) occurring during one period, an interval (Jitter_duration) between packets during one period, a number of packets (packet_loss_count/packet loss) lost during transmission of the content data, a type (interface_type) of a wireless network connected to the terminal device, a content error indicator (video_quality), an indicator (SRR) of a content transmission rate, and a moving speed (moving_speed) of the terminal device.

12. The terminal device of claim 11, wherein, when the MQI message or the NAM feedback message includes the cell ID, the MQI message or the NAM feedback message further includes information on a time at which the terminal device was located in a cell corresponding to the cell ID.

13. The terminal device of claim 11, wherein the content error indicator (video_quality) is an indicator representing at least one of a freeze error (freeze), a black error (black), and a macroblock error (mb).

14. The terminal device of claim 11, wherein the NAM feedback message further includes at least one of cross layer interface (CLI) identification information (CLI_id), an available bitrate (available_bitrate), a total buffer size (buffer_fullness), a maximum bitrate (peak_bitrate), an average bitrate (average_birate_period), a current delay time (current_delay), and a bit error rate (BER).

15. The terminal device of claim 14, wherein, when flag information (NAM_flag) in the NAM feedback message is 1, the available bitrate (available_bitrate), the total buffer size (buffer_fullness), and the maximum bitrate (peak_bitrate) denote an absolute available bitrate, an absolute total buffer size, and an absolute maximum bitrate, and
when the flag information (NAM_flag) is 0, the available bitrate (available_bitrate), the total buffer size (buffer_fullness), and the maximum bitrate (peak_bitrate) denote a relative available bitrate (relative_available_bitrate), a relative total buffer size (relative_buffer_fullness), and a relative maximum bitrate (relative_peak_bitrate).
